(19) United States
(12) Patent Application Publication
(10) Pub. No.: US 2021/0402278 A1
(43) Pub. Date: Dec. 30, 2021

(54) PEEK GOLF

(71) Applicant: Earnest A. Byner, Franklin, TN (US)

(72) Inventor: Earnest A. Byner, Franklin, TN (US)

(21) Appl. No.: 17/352,815

(22) Filed: Jun. 21, 2021

Related U.S. Application Data
(60) Provisional application No. 62/705,380, filed on Jun. 24, 2020.

(51) Int. Cl. A63B 69/36; G02C 7/16; G02C 5/00

(52) U.S. Cl. CPC A63B 69/3608; A63B 2209/10; G02C 5/003; G02C 7/16

(57) ABSTRACT

This golf training device is designed with the head movement of the golfer in mind. It is designed to train the golfer to hold the head steady or in the same place or very close to the same place throughout the golf swing which helps eliminate lateral head movement. The device helps to frame the ball in between the set of blinders and trains the golfer to keep the ball in between the blinders. The device helps to train the golfer from peeking or looking for the flight of the ball prematurely before contact is made with the golf club. The training device comprises a pair of glasses/shades with two blinders that make the golfer focus on the space which includes the ball. The blinders are for both the left side or right side and can be used at the same time or individually. The blinders can be slid back and forth along the arm of the glasses to adjust the desired length for the golfer. The device gives the golfer a frame of reference during the backswing until well after the golf ball is hit. It gives the golfer, no matter the angle he or she holds their head, a constant reference of head movement. In so doing, it allows the golfer to swing more powerfully and more consistently.

### BACKGROUND

This invention relates generally to a golfer holding the head still to improve the swing of the golf club consistently and powerfully and to help hit the ball on its attended direction. Golf is a game full of repeated, foundational consistencies. When a golfer can hold their head still consistently while swinging the club, there lies a remedy to many golfers' problems. There are other golf training devices. However, my invention of Peek Golf is the only device that fits on the head to assist the golfer in the foundational skill of maintaining head stability. It is to the advantage of the golfer that a training device be made to assist her/him in keeping the head down and still with respect to the golf swing. Because of the importance of head stability, this device also can be used while practicing chipping and putting the golf ball.

### BRIEF DESCRIPTIONS OF DRAWINGS

In all my following drawing, which form the part of the specifications and will comprise the golf training device. The number on the pictures will co-exist with the description of the parts used to make my device.

FIGS. 1 and 3 are named Blinders. This is the insides of the Blinders. Both are made of a hard plastic which will be covered with cloth that will be sewed on. They are the left and right parts of Peek Golf. Both are the same length 6 inches long and 4 inches wide. In Middle of the Blinder, 2 inches in is where a small ¼ length Velcro that is sewed to attach to the blinder. The Velcro is where the glasses attach to the blinders and enable the golfer to slide the blinders back and forth based on their preference.

FIG. 2 is a 6 inch by 4-inch piece of plastic blinder covered by cloth that is sewn around the plastic to make both blinders.

FIG. 4 is the pair of glasses/shades that the blinders will be slid on so Peek Golf can be worn while practicing golf.

FIG. 5 is the completed set for peek golf. The arms of the glasses have been slid through the Velcro slits and ready for the golfer to use. It is the combination of the blinders and the glasses/shades.

FIG. 6 is an illustration of a golfer in a full back swing with dotted lines drawn from the eyes to the ball as an example of how Peek Golf can and will be used.

FIG. 7 is and example of Peek Golf being used in a crucial part of the game (Putting).

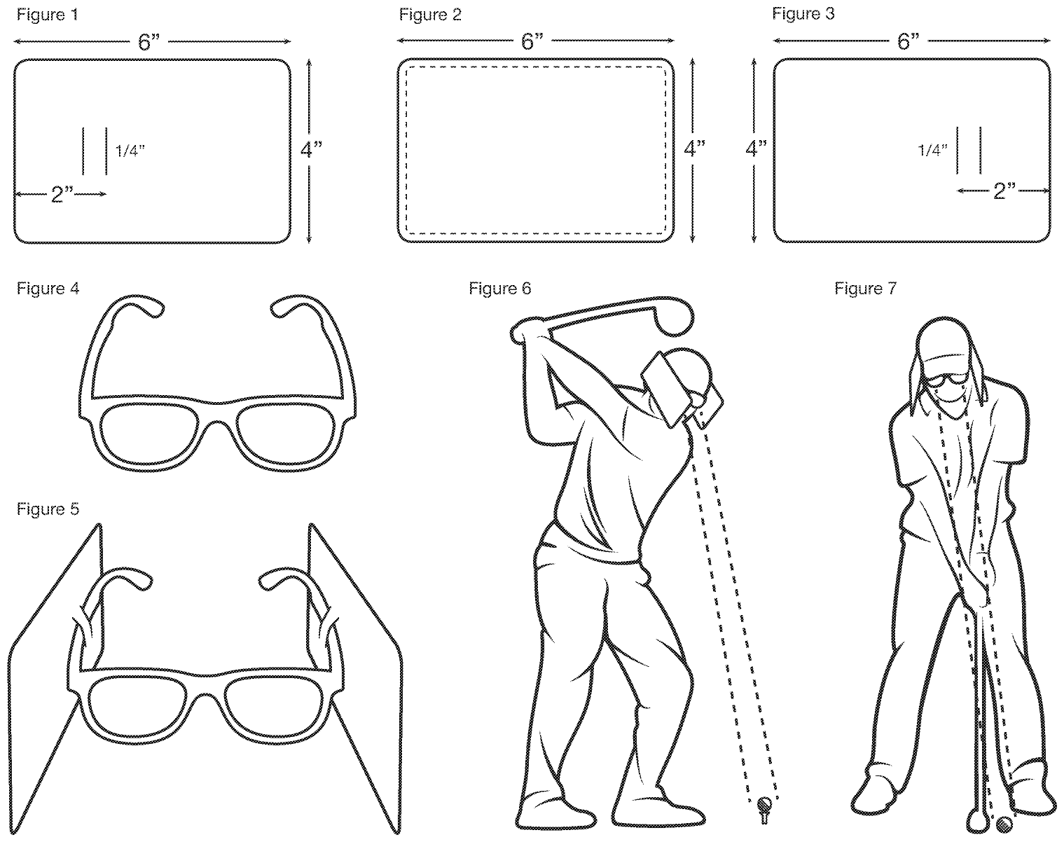

### DETAILED DESCRIPTION

Golf Head Movement Training Device

The invention relates particularly to the limiting lateral movement of the golfers' head. There is a pair of glasses/shades (1) with a left blinder (2) and a right blinder (3), each blinder slides over the left and right arm of the glasses/shades. The invention trains the golfer how to keep the head still and focus on the ball during the backswing and for most of the through swing. This simple training device relates not only to the target, but to the contact of the club on the golf ball, the direction of the golf ball and the length that the ball travels. The basic skills of a golfer are directly related to the amount of lateral head movement. No matter the chosen target or direction the golfer hits the ball, it is required to keep the head still and the eyes on the ball. heard throughout many driving ranges, golf practice facilities and on loads of golf courses and said by as many examples such as a golf pro coaching, a golf partner, keep your head down. Keeping the head still is a term that has gained steam. Keeping the head both still and down are associated with good and satisfying golf playing.

### SUMMARY OF INVENTION

My invention comprises a Golf Training Device for decreasing and limiting head movement and improving the golf swing. In particular, my device helps establish proper foundational focus on head movement and the ball.

In accordance with the presentation of this invention here is provided a training device with glasses and adjustable blinders that will help the golfer keep the head still and eyes focused on the ball during the backswing and through most of the forward swing.

In accordance with the presentation of this invention here is provided a training device help focus on keeping the head still during the backswing by wearing the blinder that's away from the target and focus on keeping the head still on the through swing by wearing the blinder nearest the target depending on whether the golfer is right or left-handed.

Typically, the golf instructor will place a golf club on the shoulder or next to the neck of the golfer as a reminder to keep the head still but has to remove it during the golf swing. With my invention, the apparatus stays on and gives feedback immediately and reinforces the position and stillness of the head or the movement that occurs.

The head is connected to the shoulders and back. The back to the hips. During the full swing as the shoulders, back and hips turn, the head stays steady or as still as possible. While chipping and putting, the movement of the head is less but the same head stillness is required to be a good consistent golfer. When you observe any golfer that plays good to great consistent golf, their head is in the same place almost throughout the entire stroke.

1. A golf training device designed to diminish the lateral head movement of the golfer to assist in more solid contact of the golf club on the golf ball.
Comprising of a pair of glasses/shades and two blinders which are left and right “with a means to attach to the glasses/shades”. The blinders have Velcro slits that slide on the arm of the glasses allowing the blinders to be shortened or elongated.
